(19) United States
(12) Patent Application Publication
(10) Pub. No.: US 2025/0156770 A1
(43) Pub. Date: May 15, 2025

(54) SYSTEMS AND METHODS FOR GENERATING FLEXIBLE ENSEMBLES OF WEAK LEARNERS USING BROKEN SERIES TRAINING

(71) Applicant: Capital One Services, LLC, McLean, VA (US)

(72) Inventor: Michael LANGFORD, Plano, TX (US)

(73) Assignee: Capital One Services, LLC, McLean, VA (US)

(21) Appl. No.: 18/510,527

(22) Filed: Nov. 15, 2023

(51) Int. Cl. G06N 20/20

(52) U.S. Cl. CPC G06N 20/20

(57) ABSTRACT

Systems and methods for novel uses and/or improvements to artificial intelligence applications, particularly in the context of practical applications featuring less complex model architectures. As one example, systems and methods described herein may achieve the technical benefits of a more complex model architecture through an ensemble of less complex models while reducing the overall training burden (e.g., in terms of computing resources, training time, and/or technical feasibility).

### BACKGROUND

In recent years, the use of artificial intelligence, including, but not limited to, machine learning, deep learning, etc. (referred to collectively herein as “artificial intelligence models,” “machine learning models,” or simply “models”) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time consuming. Additionally, data that is obtained may need to be categorized and labeled accurately, which can be a difficult, time-consuming, manual task. Second, despite the mainstream popularity of artificial intelligence, practical implementations of artificial intelligence may require specialized knowledge to design, program, and integrate artificial intelligence-based solutions, which can limit the number of people and resources available to create these practical implementations. Finally, results based on artificial intelligence can be difficult to review, as the process by which the results are made may be unknown or obscured. This obscurity can create hurdles for identifying errors in the results, as well as improving the models providing the results.

These technical problems may present an inherent problem with attempting to use an artificial intelligence-based solution and/or determining whether or not an existing artificial intelligence-based solution is properly trained. In view of the technical problems related to training artificial intelligence models, many practical applications seek to utilize less complex models with an aim to simplify the training process. However, simplifying models comes with technical trade-offs in that the resulting model may be less accurate, less precise, and/or insufficient for a given application (e.g., due to the inability of the simplified model to process the required data, detect a given pattern, and/or do so in a required amount of time).

### SUMMARY

Systems and methods are described herein for novel uses and/or improvements to artificial intelligence applications, particularly in the context of practical applications featuring less complex model architectures. As one example, systems and methods described herein may achieve the technical benefits of a more complex model architecture through an ensemble of less complex models while reducing the overall training burden (e.g., in terms of computing resources, training time, and/or technical feasibility).

The system achieves the technical benefits through the use of a plurality of weak learners in a broken series. A weak learner is a machine learning algorithm or model that performs slightly better than random chance on a classification or regression task. For example, a weak learner may be a model that has limited predictive power and is not very accurate on its own. Common examples of weak learners include decision stumps, linear regression models, shallow decision trees, and small neural networks with minimal hidden layers and nodes. While these individual models may not perform well in isolation, their combined predictions, when appropriately weighted or combined, can yield strong ensemble models like AdaBoost (adaptive boosting), Gradient Boosting, and/or Random Forests. The concept of weak learners is important in ensemble learning because these techniques aim to combine the predictions of multiple weak learners to create a strong, highly accurate predictive model. By doing so, the ensemble can compensate for the individual weaknesses of the weak learners and produce a more robust and powerful predictive model.

However, an ensemble of weak learners also creates a fundamental technical drawback. While an ensemble model (e.g., a gradient boosting model) may be used to train a series of weak learners together to create a more complex model, the use of the series of weak learners nonetheless leads to an inflexible model. An inflexible model may have limited capacity to capture the underlying patterns in the data as these models tend to make strong assumptions about overarching, linear patterns. As a result, they are less capable of fitting complex or nonlinear relationships in the data.

To overcome this technical drawback and create an ensemble of weak learners that has both a reduced training burden and an ability to fit complex or nonlinear relationships in the data, the system uses a flexible weak learner ensemble that selects a best-fit weak learner from a set of weak learning algorithms at each boosting round (e.g., using a broken series training method). For example, the system may select a weak learner from a class of weak learners at each boosting round. That is, at each boosting round, the system may fit one of the weak learners (e.g., from a class of ten) on an output of a previous round. The system may assign weights to observations in the output that have been incorrectly classified at each round. For example, at each round, the system may determine what the system continues to classify incorrectly and adjust at the end of the round. This broken series of training is in contrast to the conventional method of decision tree and/or ensemble model training in that a conventional method trains the entirety of the tree together as well as relies on the same class of weak learner at each boosting round.

However, using the broken series of training produces a novel technical problem; specifically, conventional methods of decision tree and/or ensemble model training use the same class of weak learner at each round to allow for sequential training (i.e., a round to train itself on previous outputs). By using a different class of weak learners, a subsequent weak learner may not be able to interpret the outputs of a previous weak learner. As such, the decision tree and/or ensemble model may not correct the errors made by the tree and/or ensemble of previously trained rounds.

To overcome this novel technical problem, the system validates an output at each round. Moreover, this validation may be performed using a validation metric specific to the class of weak learner used. The validation metric serves to interpret the output (e.g., identify classification and/or inaccuracies) as well as convert the output into a format that may be used by a subsequent class of weak learner. For example, the system may select the validation metric at each round (e.g., which allows for different validation metrics to be used based on the type of data received in an output). By doing so, weaknesses or mispredictions made by earlier rounds are specifically targeted and addressed by subsequent rounds. The system may then weigh the classifications in the output that the system misclassifies. By doing so, classifications that contribute errors are given higher weights, and those with less contribution have lower weights, in subsequent rounds. This weighting scheme ensures that the ensemble gives more importance to potential inaccuracies such that the model may better capture underlying patterns in the data that may be complex and/or nonlinear.

Notably, as a byproduct of the use of a different class of weak learner at each round and/or the use of the additional class-specific validation metric, the training of the ensemble becomes longer (and/or more computationally intensive). However, compensating for this, the resulting model is a stronger learner and requires fewer rounds.

In some aspects, systems and methods for generating flexible ensembles of weak learners using broken series training are described. For example, the system may receive a first dataset. The system may generate a first feature input based on the first dataset. The system may input the first feature input into a first weak learner of a plurality of weak learners, wherein the first weak learner corresponds to a first class of a plurality of weak learner classes. The system may receive a first output from the first weak learner. The system may compare the first output to a first validation metric, wherein the first validation metric is based on the first class. The system may adjust a first weight based on comparing the first output to the first validation metric. The system may generate, for a second weak learner of the plurality of weak learners, a second feature input based on the first weight and the first output. The system may generate a classification for data in the first dataset based on the second feature input.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for generating flexible ensembles of weak learners using broken series training, in accordance with one or more embodiments.

FIG. 2A shows an illustrative diagram of time-series data, in accordance with one or more embodiments.

FIG. 2B shows an illustrative user interface for automating model selection and feature engineering, in accordance with one or more embodiments.

FIG. 3 shows illustrative components for a system used to automate model selection based on dataset fittings of time-series data prior to hyperparameter optimization, in accordance with one or more embodiments.

FIG. 4 shows a flowchart of the steps involved in generating flexible ensembles of weak learners using broken series training, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

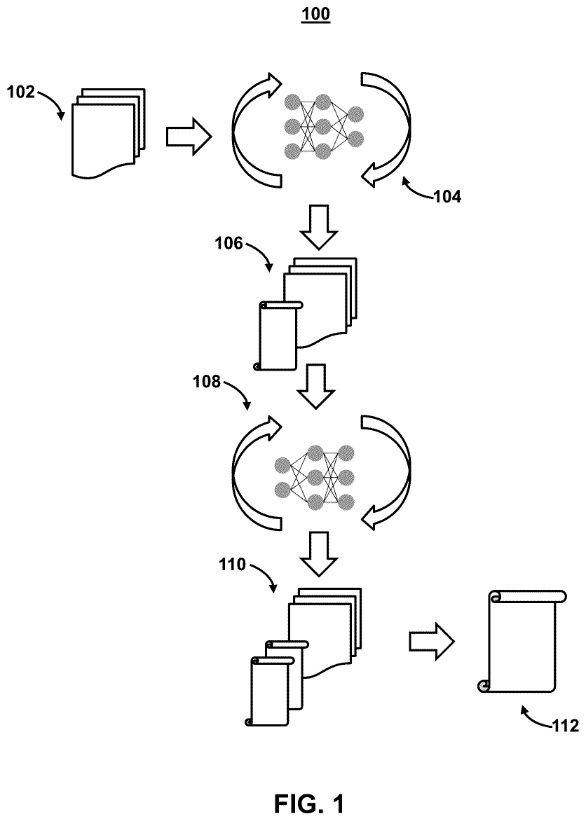

FIG. 1 shows an illustrative diagram for generating flexible ensembles of weak learners using broken series training, in accordance with one or more embodiments. For example, systems and methods are described herein for novel uses and/or improvements to artificial intelligence applications, particularly in the context of practical applications featuring less complex model architectures. As one example, systems and methods described herein may achieve the technical benefits of a more complex model architecture through an ensemble of less complex models while reducing the overall training burden (e.g., in terms of computing resources, training time, and/or technical feasibility).

Weak learners are models or algorithms that have limited predictive power and perform only slightly better than random chance. Weak learners are often simple models with low complexity. To provide more complex determinations, the system may use ensemble learning to create stronger, more accurate predictive models. An ensemble learner is a model that combines the predictions of multiple individual models (learners) to produce a more accurate and robust prediction. Ensemble learning aggregates the output of diverse models. By doing so, the ensemble can outperform any individual model, leading to improved generalization and predictive performance. In some embodiments, the ensemble model may use bagging and/or boosting.

In bagging, multiple instances of the same base model are trained on different random subsets (with replacement) of the training data. Each base model produces a prediction, and the final prediction is typically obtained by averaging (for regression) or using a majority vote (for classification) over the predictions of all base models. One example of a bagging algorithm is Random Forest, which uses decision trees as base models.

In boosting, base models are trained sequentially, and each new model is trained to correct the errors made by the ensemble of previous models. Boosting assigns weights to data points, giving more weight to the examples that were misclassified by the previous models. Some examples of boosting algorithms include AdaBoost, Gradient Boosting (including implementations like XGBoost, LightGBM, and CatBoost), and Stochastic Gradient Boosting (SGD Boosting).

Ensemble learning provides several advantages, including improved accuracy (e.g., ensembles often have higher predictive accuracy than individual models because they can capture different aspects of the data), robustness (e.g., ensembles are less prone to overfitting since errors in individual models can be compensated for by others), generalization (e.g., ensembles can generalize well to new, unseen data, even when the individual models may not), and/or reduced variance (e.g., bagging, in particular, reduces the variance of a model, which can help stabilize predictions). Ensemble learning may be used to improve model performance in many real-world applications. The choice of ensemble method and the combination of base models depend on the specific problem and dataset characteristics, and different ensemble techniques may perform better in different scenarios.

For example, the weak learner ensemble may comprise several classes or types of weak learners. These classes may include decision stumps, linear models, decision trees, perceptrons, K-Nearest Neighbors (KNNs), naïve Bayes classifiers, Simple Neural Networks, constant predictors, majority class predictors, weak rule-based models, etc. Decision stumps are the simplest form of decision trees. They have a single decision node and two leaf nodes, making binary decisions based on one feature. Decision stumps are often used in ensemble methods like AdaBoost. Linear models, such as linear regression or logistic regression, are simple models that assume a linear relationship between input features and the target variable. They are often used as weak learners in ensembles like Linear Boosting. Decision trees with limited depth (few nodes and splits) are often considered weak learners. They capture simple decision boundaries and are used in ensemble methods like Random Forests and Gradient Boosting. Perceptrons are single-layer neural networks used for binary classification tasks. They have a linear decision boundary and can serve as weak learners in ensemble methods. KNNs, when used with a small value of k, can act as a weak learner. They make predictions based on the majority class of its nearest neighbors and may perform only slightly better than random guessing. Naïve Bayes classifiers, which make predictions based on probabilistic models and feature independence assumptions, can be used as weak learners, particularly in ensemble methods like AdaBoost. Simple feedforward neural networks with a small number of hidden layers and nodes can be considered weak learners, especially in the context of ensemble learning. A constant predictor always predicts the same value, such as the mean or median of the target variable. While extremely simple, it can serve as a baseline weak learner. A majority class predictor always predicts the majority class in a classification problem. It can be used as a weak learner in cases of class imbalance. Weak rule-based models, such as rule sets or rule-based classifiers, are often simple and interpretable. They can be used as weak learners in ensemble methods.

As shown in FIG. 1, system 100 may receive a first dataset (e.g., dataset 102) for classification using an artificial intelligence model comprising an ensemble of weak learners. The system may generate a first feature input based on the first dataset and input the first feature input into a first weak learner (e.g., weak learner 104) of a plurality of weak learners in the artificial intelligence model, wherein the first weak learner corresponds to a first class of a plurality of weak learner classes.

A “feature input” may refer to the variables or attributes that are provided as input to a machine learning model for the purpose of making predictions or generating insights. Features are the characteristics or properties of the data that the model uses to learn patterns and relationships. Feature inputs are also sometimes called “predictors” or “input variables.” Feature inputs are essential components of machine learning models. They represent the information or data that the model uses to make predictions or decisions. For example, in a spam email classifier, the features might include the words contained in an email, the sender's address, and the email's subject line. Features can take various forms, including numerical (e.g., age, temperature), categorical (e.g., color, product category), ordinal (e.g., education level, customer satisfaction rating), and more. Features can also be derived or engineered from the original data, such as calculating ratios, aggregating statistics, or encoding categorical variables into numerical representations. Feature engineering is the process of selecting, transforming, and creating features to improve a model's performance. It involves identifying relevant features, handling missing data, normalizing or scaling features, and creating new features that may capture important patterns in the data. Feature selection is the process of choosing the most informative features while discarding irrelevant or redundant ones. This can help simplify the model, reduce overfitting, and improve computational efficiency. Some machine learning algorithms, such as decision trees and random forests, provide measures of feature importance. These measures indicate the contribution of each feature to the model's predictions. Feature importance can be used for feature selection and interpretation. Feature preprocessing involves tasks like data cleaning, encoding categorical variables, handling outliers, and scaling or normalizing numerical features to ensure that the data is suitable for modeling. Feature extraction is the process of reducing the dimensionality of data by transforming it into a smaller set of relevant features (e.g., using techniques like Principal Component Analysis (PCA) and dimensionality reduction).

The system may receive a first output (e.g., output 106) from the first weak learner. The system may compare the first output to a first validation metric, wherein the first validation metric is based on the first class. The system may adjust a first weight based on comparing the first output to the first validation metric.

Classification models and/or individual weak learners may be evaluated using metrics such as accuracy, precision, recall, F1-score, and area under the ROC curve (AUC-ROC) to assess their performance. These metrics help measure how well the model classifies data into the correct categories. In some embodiments, the system may make a binary vs. multi-class classification. In binary classification, there are only two possible classes (e.g., spam or not spam). In multi-class classification, there are more than two classes (e.g., classifying objects into multiple categories, such as cats, dogs, and birds).

Validation metrics for a weak learner may depend on the specific task (classification or regression) and the nature of the data. The system may make these determinations based on a class of the weak learner. These validation metrics may be used to assess the performance of the model on a validation dataset, which is a subset of the data that was not used for training.

The validation metric may be based on accuracy, precision, recall, F1-score, AUC-ROC, Area Under the Precision-Recall Curve (AUC-PR), and/or regression metrics. Accuracy is the proportion of correctly classified instances out of all instances in the validation dataset. It is a simple and commonly used metric but may not be suitable for imbalanced datasets. Precision measures the ratio of true positive predictions to the total number of positive predictions. It is used when the cost of false positives is high. Precision=TP/(TP+FP). Recall measures the ratio of true positive predictions to the total number of actual positives. It is used when the cost of false negatives is high. Recall=TP/(TP+FN). The F1-score is the harmonic mean of precision and recall. It balances the trade-off between precision and recall and is useful when you want to consider both false positives and false negatives. AUC-ROC measures the area under the receiver operating characteristic (ROC) curve. It is particularly useful for binary classification problems and assesses the model's ability to discriminate between the positive and negative classes. AUC-PR measures the area under the precision-recall curve, which is often used when dealing with imbalanced datasets. Regression metrics for weak learners may comprise Mean Absolute Error (MAE), Mean Squared Error (MSE), Root Mean Squared Error (RMSE), Mean Absolute Percentage Error (MAPE), R-squared (R2), and Mean Bias Deviation (MBD).

MAE calculates the average absolute difference between predicted and actual values. It is less sensitive to outliers compared to MSE. MAE=(1/n) Σ|predicted−actual|. MSE calculates the average squared difference between predicted and actual values. It emphasizes larger errors and is commonly used for regression tasks. MSE=(1/n) Σ(predicted-actual)\hat{ }2. RMSE is the square root of MSE and provides a measure of the error in the same units as the target variable. RMSE=sqrt (MSE). MAPE calculates the average percentage difference between predicted and actual values. It is often used in cases where relative errors are important. MAPE=(1/n) Σ(|(predicted−actual)/actual|*100%). R-squared measures the proportion of the variance in the target variable that is explained by the model. It ranges from 0 to 1, with higher values indicating better model fit. MBD measures the average bias of the predictions, which is the difference between predicted and actual values.

The system may generate a second feature input (e.g., weak learner 108) based on the first weight and the first output and input the second feature input into a second weak learner of the plurality of weak learners, wherein the second weak learner corresponds to a second class of a plurality of weak learner classes.

A “weight” may refer to a numerical parameter that the model uses to make predictions or decisions. These weights are a fundamental component of the model's architecture and are adjusted during the training process to enable the model to learn from the data. In artificial neural networks, which are a class of machine learning models inspired by the structure of the human brain, weights represent the strength of connections between neurons. Each connection between neurons has an associated weight. These weights determine how much influence the output of one neuron has on the input of another.

During training, the model adjusts these weights through a process called backpropagation and gradient descent. The goal is to minimize the difference between the model's predictions and the true target values by updating the weights. In linear models such as linear regression and logistic regression, weights are coefficients assigned to each input feature. These weights determine the contribution of each feature to the model's output. The model's prediction is typically computed as a weighted sum of the input features, and the weights are adjusted during training to fit the data by minimizing a loss function. In ensemble learning, which combines multiple models to make predictions, weights are often associated with the contribution of each individual model to the ensemble's final prediction. Models that perform better on the training data may be assigned higher weights in the ensemble. In Support Vector Machines (SVMs), weights correspond to the coefficients of the hyperplane that separates different classes in a classification problem. The SVM seeks to find the hyperplane that maximizes the margin between classes, and the weights are part of this hyperplane equation. Weights essentially represent the “learned knowledge” of the model, reflecting the importance or influence of different parameters or features in making predictions. During the training process, the model's goal is to adjust these weights to minimize prediction errors and improve its ability to generalize to new, unseen data. This process of learning the optimal weights is a core aspect of supervised machine learning, where models learn patterns and relationships in data to make predictions or classifications.

The system may receive a second output (e.g., output 110) from the second weak learner and compare the second output to a second validation metric, wherein the second validation metric is based on the second class. The system may adjust a second weight based on comparing the second output to a second validation metric.

The system may generate, from the artificial intelligence model, a classification (e.g., classification 112) for data in the first dataset based on the second weight and the second output. Classification in a model may refer to the process of categorizing or assigning predefined labels or classes to input data based on its characteristics or features. It is a type of supervised machine learning task where the model learns to make predictions by classifying data points into one of several distinct categories or classes. Classification problems are prevalent in various domains, including image recognition, natural language processing, spam email detection, medical diagnosis, and more. Classification may comprise distinct labels or categories into which data points are classified. For example, in an email classification task, classes could be “spam” and “not spam,” while in image recognition, classes might represent different objects or objects' characteristics. The system may make classifications based on features (or feature inputs) in a dataset. Features are the input variables or attributes that describe the characteristics of the data points. In a classification problem, the model uses these features to make predictions. For instance, in text classification, features might be words or phrases present in a document, while in image classification, features could be pixel values or higher-level image descriptors. In supervised classification, the model is trained on a labeled dataset, which consists of input data and corresponding class labels. During training, the model learns the relationship between the features and the class labels by adjusting its internal parameters (weights) to minimize prediction errors. Various algorithms can be used for classification tasks, including decision trees, SVMs, KNNs, logistic regression, naïve Bayes, and deep neural networks. The choice of algorithm depends on the nature of the data and the specific problem.

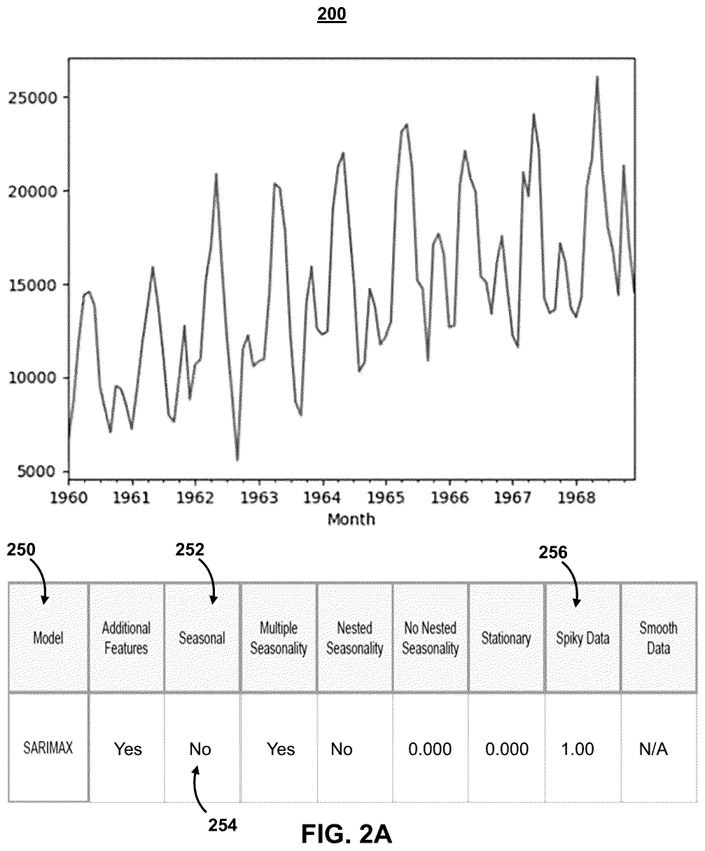

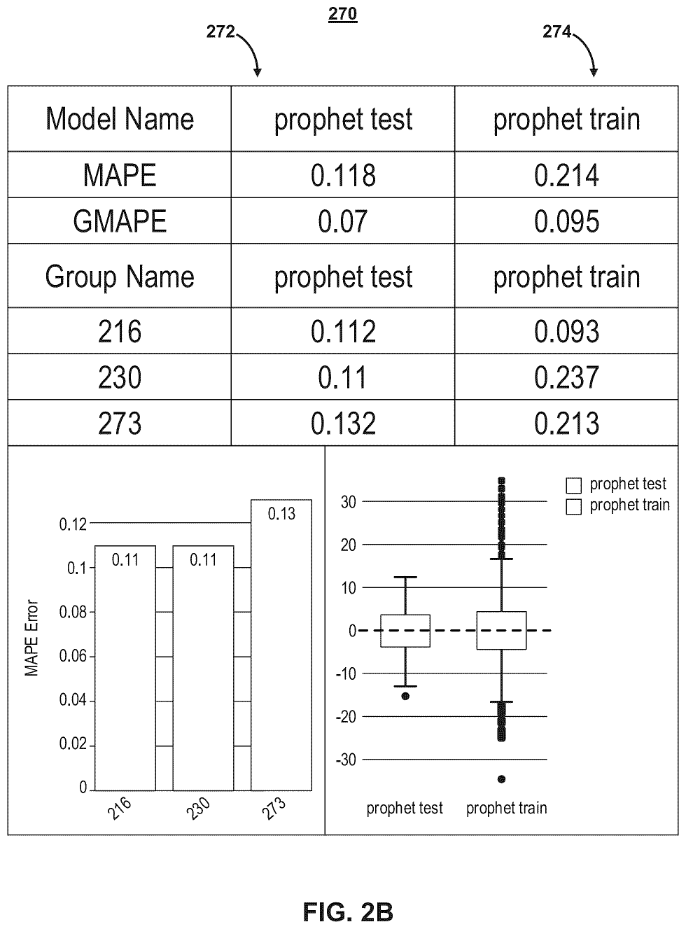

FIG. 2A shows an illustrative diagram of time-series data, in accordance with one or more embodiments. For example, dataset 200 may comprise data requiring feature engineering. Additionally or alternatively, a system may use dataset 200 to minimize development time in artificial intelligence models by automating model selection based on dataset fittings of time-series data. As part of that development, the system may perform feature engineering. As described herein, a model development life cycle may involve the various stages and processes involved in creating, training, evaluating, deploying, and/or maintaining models. It is a structured framework that helps guide the development of models in a systematic and effective manner.

As stated above, in the model development life cycle, choosing the best model to fit a given dataset and optimizing its hyperparameters is an incredibly time-consuming and tedious process. This is particularly true for time-series data. For example, in time-series forecasting, some models will be better suited to fit a given dataset of certain attributes, such as the seasonal periods, presence of trends, and/or smoothness of the data. As such, certain time-series forecasting models may not be effective if there is no seasonality present in the data, whereas other time-series forecasting models may be very effective if the dataset is stationary. Accordingly, information about these attributes (e.g., a profile) of the time-series dataset may be used to help determine which model may be most effective at fitting a given dataset.

Fitting a dataset in artificial intelligence models may refer to the process of training a model using available data. Before fitting a dataset, the system may need to preprocess the data to make it suitable for training. This includes tasks such as handling missing values, scaling/normalizing features, encoding categorical variables, and splitting the dataset into training and testing sets. The system may then select an algorithm or model that is appropriate for a task. The choice of the model depends on the type of problem (classification, regression, clustering, etc.) and the characteristics of the data. The system may create an instance of the chosen model and configure its hyperparameters. Hyperparameters control various aspects of the learning process, and the system may need to experiment with different values to achieve optimal performance. The system may then use training data to train (fit) the model. This involves presenting the input features and corresponding target labels (or output) to the model so that it can learn the underlying patterns in the data. During training, the model may use a loss function to measure how well it is performing compared to the actual target values. The optimization algorithm (like stochastic gradient descent) then adjusts the model's parameters (weights and biases) to minimize this loss function. The training process is usually performed in iterations or epochs. In each iteration, the model updates its parameters based on a subset of the training data. This helps the model gradually improve its performance. After each epoch, the system can evaluate the model's performance on a validation set. This helps the system monitor how well the model is generalizing to data it has not seen before.

For example, the system may receive a first dataset, wherein the first dataset comprises one or more categories of data trends. A dataset may comprise a structured collection of data points, usually organized into rows and columns, that is used for various purposes, including analysis, research, and training machine learning models. Datasets contain information related to a specific topic, domain, or problem and are used to extract meaningful insights or to train and evaluate algorithms and models. In the context of machine learning, a dataset typically consists of two main components: features and labels. Features (or attributes) are the characteristics or variables that describe each data point. Features are represented as columns in a tabular dataset. For example, if the system is working with a dataset of houses, features could include attributes like the number of bedrooms, square footage, location, etc. Labels, in contrast, may comprise targets and/or responses. For example, in supervised learning tasks, each data point often has an associated label that represents the output or target value the system wants the model to predict. For instance, if the system is building a model to predict house prices, the labels would be the actual prices of the houses in the dataset. Datasets come in various formats and sizes, ranging from small tables with a few rows and columns to large and complex databases containing millions of records. They can be generated manually, collected from real-world sources, or obtained from publicly available repositories. Common types of datasets include structured datasets (e.g., tabular datasets with rows and columns, often stored in formats like CSV (Comma-Separated Values), Excel spreadsheets, or databases); image datasets (e.g., collections of images, often used for computer vision tasks; each image is treated as a data point, and the pixels constitute the features); text datasets (e.g., textual data, such as reviews, articles, or tweets, which can be used for natural language processing (NLP) tasks); time-series datasets (e.g., sequences of data points ordered by time, such as stock prices, weather measurements, or sensor readings); and graph datasets (e.g., data organized in a graph structure, with nodes and edges representing relationships between entities). Datasets are fundamental for various data-driven tasks, including exploratory data analysis, statistical analysis, and machine learning model development and evaluation.

Dataset 200 may comprise time-series data. As described herein, “time-series data” may include a sequence of data points that occur in successive order over some period of time. In some embodiments, time-series data may be contrasted with cross-sectional data, which captures a point in time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time-series analysis. For example, a time-series analysis may be useful to see how a given asset, security, and/or value related to other content changes over time. It can also be used to examine how the changes associated with the chosen data point compare to shifts in other variables over the same time period. For example, with regard to retail loss, the system may receive time-series data for the various sub-segments indicating daily values for theft, product returns, etc.

The time-series analysis may determine various trends, such as a secular trend, which describes the movement along the term; a seasonal variation, which represents seasonal changes; cyclical fluctuations, which correspond to periodical but not seasonal variations; and irregular variations, which are other nonrandom sources of variations of series. The system may maintain correlations for this data during modeling. In particular, the system may maintain correlations through non-normalization, as normalizing data inherently changes the underlying data that may render correlations, if any, undetectable and/or lead to the detection of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches depend heavily on the normalization choices. Thus, normalization may lead to lower model performance and more model errors. The use of a non-parametric bias test alleviates the need for normalization while still allowing the methods and systems to determine a respective proportion of error detections for each of the plurality of time-series data component models. Through this unconventional arrangement and architecture, the limitations of the conventional systems are overcome. For example, non-parametric bias tests are robust to irregular distributions while providing an allowance for covariate adjustment. Since no distributional assumptions are made, these tests may be applied to data that has been processed under any normalization strategy or not processed under a normalization process at all.

As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time-series data as a data stream. A given increment (or instance) of the time-series data may correspond to a data stream segment.

For example, in some embodiments, the analysis of time-series data presents comparison challenges that are exacerbated by normalization. For example, a comparison of original data from the same period in each year does not completely remove all seasonal effects. Certain holidays, such as Easter and Lunar New Year, fall in different periods in each year; hence, they will distort observations. Also, year-to-year values will be biased by any changes in seasonal patterns that occur over time. For example, consider a comparison between two consecutive March months (i.e., compare the level of the original series observed in March for 2023 and 2024). This comparison ignores the moving holiday effect of Easter. Easter occurs in April for most years, but if Easter falls in March, the level of activity can vary greatly for that month for some series. This distorts the original estimates. A comparison of these two months will not reflect the underlying pattern of the data. The comparison also ignores trading day effects. If the two consecutive months of March have a different composition of trading days, it might reflect different levels of activity in original terms even though the underlying level of activity is unchanged. In a similar way, any changes to seasonal patterns might also be ignored. The original estimates also contain the influence of the irregular component. If the magnitude of the irregular component of a series is strong compared with the magnitude of the trend component, the underlying direction of the series can be distorted. While data may, in some cases, be normalized to account for this issue, the normalization of one data stream segment (e.g., for one component model) may affect another data stream segment (e.g., for another component model). Individual normalizations may distort the relationship and correlations between the data, leading to issues and negative performance of a composite data model.

Table 250 may indicate outputs of a plurality of statistical models. For example, each row of table 250 may correspond to a model used to generate predictions based on a given dataset (e.g., “SARIMAX” in table 250), whereas each column of table 250 may correspond to a given statistical model that performs a different statistical analysis. For example, a first model of the plurality of statistical models (e.g., corresponding to column 252) may determine a value used to predict seasonality in data. The system may then use the value (e.g., value 254) to apply a score (e.g., score 256 (FIG. 2A)).

As referred to herein, a statistical analysis may encompass techniques used to analyze data and extract meaningful insights. These techniques help researchers, analysts, and data scientists understand patterns, relationships, and trends in data. In some embodiments, the system may determine whether data is spiky based on score 256.

For example, for automated model selection for time-series datasets, it is important to be able to determine whether or not the dataset contains “spiky” data-data that contains large swings—as certain time-series models cannot be fit properly to data that exhibits spikiness. The system may achieve this by scanning a given dataset for periods of spikiness that are independent of the specific range of the overall dataset and do not use any measure of variance of the data.

For example, the system may receive a time-series dataset. The system may then determine a number of points to check within a sliding window across the dataset, as well as a maximum tolerable percent change with respect to the current range of the data in the sliding window that determines the threshold for calling data spiky (e.g., a “spiky threshold”), and its value may be between 0 and 1.

For this process, the system iterates through the time-series dataset from the beginning, choosing a sliding window of a size of the number (N) of points the user selected. For each sliding window of N points, the system finds the range between the maximum and minimum values in the window. The system then determines the successive differences between each value of the points in the window and divides them by the window's range. If the absolute value of any of these values is greater than the spiky threshold value set by the user, the system exits of the process and returns the dataset with an indication that it contained spiky data. If it ran to completion without identifying any spiky data, the system exits and returns an indication that it did not identify spiky data at the given parameters.

One type or category of statistical analysis is descriptive statistics. Descriptive statistics summarize and describe the main features of a dataset. This includes measures like mean, median, mode, standard deviation, variance, and percentiles. Descriptive statistics provide a basic overview of the data's central tendency, variability, and distribution. Table 250 may list these results as an array of data values that comprises an aggregate statistical profile for a given model, wherein the given model may be used to generate predictions based on the dataset.

Another type of statistical analysis is inferential statistics. Inferential statistics involve making predictions or drawing conclusions about a population based on a sample of data. Techniques like hypothesis testing, confidence intervals, and regression analysis are used to infer insights about larger datasets. Another type of statistical analysis is hypothesis testing. Hypothesis testing is used to make decisions about whether a particular hypothesis about a population is likely true or not. It involves comparing sample data to a null hypothesis and assessing the likelihood of observing the data if the null hypothesis is true.

Another type of statistical analysis is regression analysis. Regression analysis is used to understand the relationship between one or more independent variables (features) and a dependent variable (target). It helps model the relationship and predict the value of the dependent variable based on the values of the independent variables. Another type of statistical analysis is analysis of variance (ANOVA). ANOVA is used to analyze the differences among group means in a dataset. It is often used when there are more than two groups to compare. ANOVA assesses whether the means of different groups are statistically significant. Another type of statistical analysis is a chi-square test. The chi-square test is used to determine if there is a significant association between categorical variables. It is commonly used to analyze contingency tables and assess whether observed frequencies are significantly different from expected frequencies. Another type of statistical analysis is time-series analysis. Time-series analysis focuses on data points collected over time. Techniques like moving averages, exponential smoothing, and autoregressive integrated moving average (ARIMA) models are used to analyze trends, seasonality, and patterns in time-series data. Another type of statistical analysis is cluster analysis. Cluster analysis is used to group similar data points together based on their characteristics. It is often used for segmentation and pattern recognition in unsupervised learning tasks.

Another type of statistical analysis is factor analysis. Factor analysis is used to identify patterns of relationships among variables. It aims to reduce the number of variables by grouping them into latent factors that explain the underlying variance in the data. Another type of statistical analysis is PCA. PCA is a dimensionality reduction technique that transforms high-dimensional data into a lower-dimensional space while retaining as much variance as possible. It is commonly used to reduce noise and extract important features from data.

FIG. 2B shows an illustrative user interface for automating model selection and hyperparameter optimization, in accordance with one or more embodiments. For example, user interface 270 may represent an interface used to perform model selection and/or adjust hyperparameter optimization. For example, user interface 270 may be used to review model and/or hyperparameter performance (e.g., in order to train, tune, and/or fit models and/or hyperparameters).

The system may perform hyperparameter tuning to optimize the model's settings for better performance. For example, the system may compare test performance 272, which may comprise a performance performed by a model on test data to train performance 274, which may comprise a performance performed by a model on test data to train performance. Once the training is complete and the system meets a threshold level of performance, the system can evaluate its performance on a separate testing dataset. This gives the system a final assessment of how well the model is expected to perform on new, unseen data. If the model meets the performance requirements, the system can deploy it to make predictions on new data. This may involve integrating the trained model into another application or system. The fitting process involves a balance between underfitting (when the model is too simple to capture the underlying patterns) and overfitting (when the model learns noise in the training data and performs poorly on new data). Regularization techniques and careful model selection can help mitigate these issues. Overall, fitting a dataset involves selecting a model, training it on the data, monitoring its performance, and optimizing its settings for the best results.

As referred to herein, a “modeling error” or simply an “error” may correspond to an error in the performance of the model. In some embodiments, an error may be used to determine an effect on performance of a model. For example, an error in a model may comprise an inaccurate or imprecise output or prediction for the model. This inaccuracy or imprecision may manifest as a false positive or a lack of detection of a certain event. These errors may occur in models corresponding to a particular hyperparameter, which results in inaccuracies for predictions and/or output based on the hyperparameter, and/or the errors may occur in models corresponding to an aggregation of multiple hyperparameters that result in inaccuracies for predictions and/or outputs based on errors received in one or more of predictions of the plurality of hyperparameters and/or an interpretation of the predictions of the models based on the plurality of hyperparameters. In some embodiments, each model (or test) of the plurality of models (or statistical tests) may test for a different statistical variation (e.g., smoothness, spiky data, seasonality, etc.). To determine the statistical variation for the first model over the first time period, the system may need to calculate descriptive statistics that provide insights into the variability of the data. For example, the system may gather the data (e.g., form the first dataset) over the first time period. This could be any relevant metric that the system wants to analyze, such as accuracy, error rate, revenue, etc., as well as other statistical metrics (e.g., mean, average, standard deviation, etc.). For example, the system may calculate descriptive statistics such as mean, variance, and/or standard deviation. To determine a mean, the system may add up all the data points and divide by the number of data points to get the average. The mean provides an overall sense of central tendency. To determine variance for each data point, the system calculates the squared difference from the mean. The system may then sum up these squared differences and divide by the number of data points. Variance measures how much the data points spread out from the mean. For standard deviation, the system takes the square root of the variance. The standard deviation is a commonly used measure of dispersion or spread. For example, the system may determine a first time period for a first model (or test) of the first plurality of models (or statistical tests). The system may determine a first statistical variation for the first model over the first time period. The system may determine a feature number of the first plurality of feature numbers for the first model based on the first statistical variation.

Hyperparameter tuning is the process of selecting the optimal values for hyperparameters in a machine learning model. Hyperparameters are parameters that are set before the learning process begins and control various aspects of the training process. They are not learned from the data but are determined by the user or data scientist based on domain knowledge, experimentation, and heuristics. Some examples of hyperparameters in machine learning algorithms include learning rate, regularization strength, number of hidden units or layers in a neural network, kernel parameters in SVMs, and so on. For example, hyperparameters can include learning rate, batch size, number of hidden layers in a neural network, regularization strength, kernel size in a convolutional neural network, and more. These choices influence how the model learns from the data and generalizes to new, unseen data. Hyperparameter performance may be a measure of how effective a particular set of hyperparameters is in producing a model that performs well on a specific task. To do so, the system may use techniques like cross-validation or holdout validation, where the dataset is split into training and validation subsets. Different sets of hyperparameters are tried, and the performance of the resulting models is measured on the validation data. For example, the goal when tuning hyperparameters is to find the best combination that leads to optimal model performance. This can be a delicate balance, as adjusting hyperparameters too much might lead to overfitting or poor generalization, while not adjusting them enough could result in an underperforming model.

Hyperparameter tuning is important because the performance of a machine learning model is highly dependent on the values of these hyperparameters. Poorly chosen hyperparameters can lead to suboptimal model performance, including overfitting or underfitting. The goal of hyperparameter tuning is to find the set of hyperparameters that results in the best possible performance on the validation or test dataset. Hyperparameter tuning is typically an iterative process that involves trying different values for various hyperparameters, observing the impact on performance, and refining the choices based on those observations. Automated techniques, such as grid search, random search, and more advanced methods like Bayesian optimization, are often employed to systematically explore the hyperparameter space and find the combination that leads to the best performance on the validation data.

There are several methods for hyperparameter tuning, including grid searching. This involves specifying a grid of possible hyperparameter values and systematically trying out all combinations of values. It is simple but can be computationally expensive. Another example of hyperparameter tuning is random search. Instead of trying all possible combinations, random search samples a fixed number of random combinations from the hyperparameter space. This can be more efficient than grid search. Another example of hyperparameter tuning is Bayesian optimization. This is a more sophisticated approach that builds a probabilistic model of the relationship between hyperparameters and model performance. It then uses this model to intelligently select the next set of hyperparameters to try. Another example of hyperparameter tuning is gradient-based optimization. Some frameworks allow for using gradient-based optimization techniques to directly optimize hyperparameters alongside the model parameters.

The process of hyperparameter tuning involves a balance between exploration and exploitation. Exploring different hyperparameter values helps to find a better region in the hyperparameter space, while exploiting promising regions helps to refine the hyperparameter settings for optimal performance. Overall, hyperparameter tuning is a crucial step in the machine learning pipeline to achieve the best possible model performance on new, unseen data.

For example, the system may tune the first untuned hyperparameter to the specific value. To make an untrained model useful, it needs to go through a training process. During training, the model is exposed to a labeled dataset, and it learns to adjust its parameters based on the input features and corresponding target labels. The optimization process (often using techniques like gradient descent) iteratively updates the model's parameters to minimize the difference between its predictions and the actual labels in the training data. For example, the entire hyperparameter tuning process may be guided by a JSON that contains the following: every possible model; for each model, a set of hyperparameters that are “eligible” for tuning; and for each hyperparameter, a data type of the hyperparameter (integer, float, categorical, string, etc.) and a range of possible values for the hyperparameter.

From a main template of all this documented model and hyperparameter information, the system will pull a copy of the template to adjust for the specific dataset. For the specific dataset, statistical tests may be performed to determine specific information about the profile of the dataset, such as the presence of trends, whether there is additive or multiplicative seasonality, or the length of the seasonal periods in the dataset. Any specific values found are then mapped to the specific hyperparameters they relate to in each of the candidate models. The system may then update the hyperparameter tuning JSON file to set the known value for the hyperparameter as what was discovered through the statistical tests. As such, every considered model may have this hyperparameter value pinned, and it will not be considered for any tuning as it is already known.

The candidate models are then fit and tuned to the dataset. The system returns the model that performs best using an expanding window validation strategy. The system may also return a simple report detailing the known hyperparameters about the dataset profile that are discovered with the tests. Through this training process, the model learns to recognize patterns, relationships, and features in the data, allowing it to make accurate predictions or classifications on new, unseen data. The process of training a model involves adjusting its parameters to fit the training data and capture the underlying patterns, which is why an untrained model is not yet capable of performing the desired task.

In some embodiments, the system may tune the first untuned hyperparameter to the specific value to generate a tuned first model. The system may then generate for display, on a user interface, a recommendation for using the tuned first model for time-series forecasting. For example, generating recommendations on a user interface may involve leveraging algorithms and techniques to suggest relevant items, content, or actions to users based on their preferences, behaviors, and/or historical interactions.

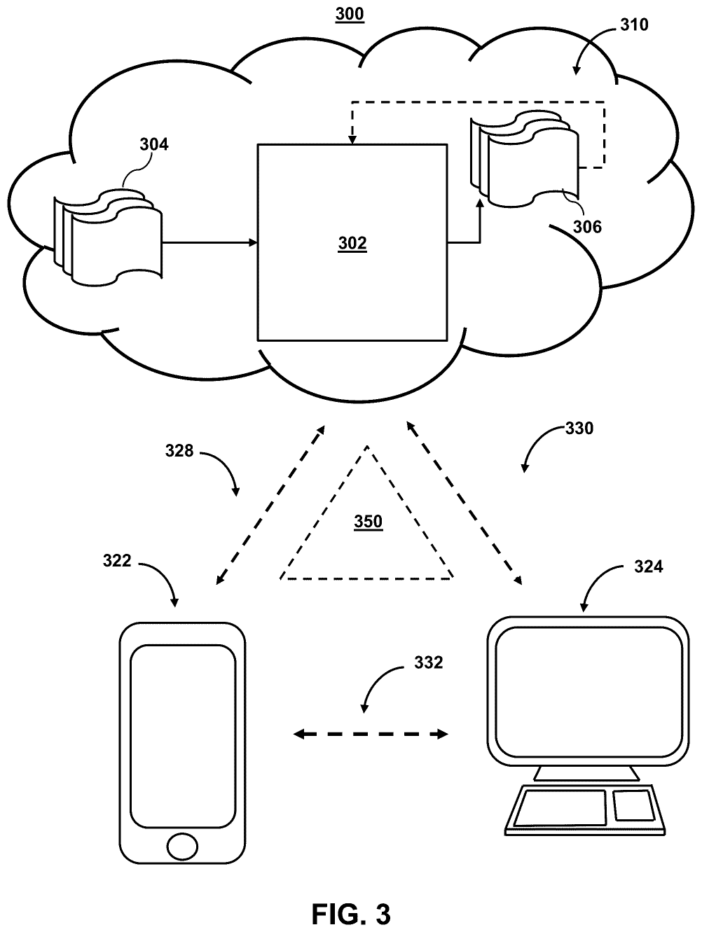

FIG. 3 shows illustrative components for a system used to automate model selection based on dataset fittings of time-series data prior to hyperparameter optimization, in accordance with one or more embodiments. For example, FIG. 3 may show illustrative components for minimizing development time in artificial intelligence models by automating model selection based on dataset fittings of time-series data prior to hyperparameter optimization. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., recommendations, queries, and/or notifications).

Additionally, as mobile device 322 and user terminal 324 are shown as monitors, these displays also act as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, virtual private networks, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., one or more categories of data trends and/or other predictions).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free flowing, with connections interacting in a more chaotic and complex fashion. During testing, an output layer of model 302 may indicate whether or not a given input corresponds to a classification of model 302 (e.g., one or more categories of data trends and/or other predictions).

In some embodiments, the model (e.g., model 302) may automatically perform actions based on outputs 306. In some embodiments, the model (e.g., model 302) may not perform any actions. The output of the model (e.g., model 302) may be used to generate recommendations and/or other predictions.

System 300 also includes API (“Application Programming Interface”) layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of API layer 350 may provide integration between front-end and back-end. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDoS protection, and API layer 350 may use RESTful APIs as standard for external integration.

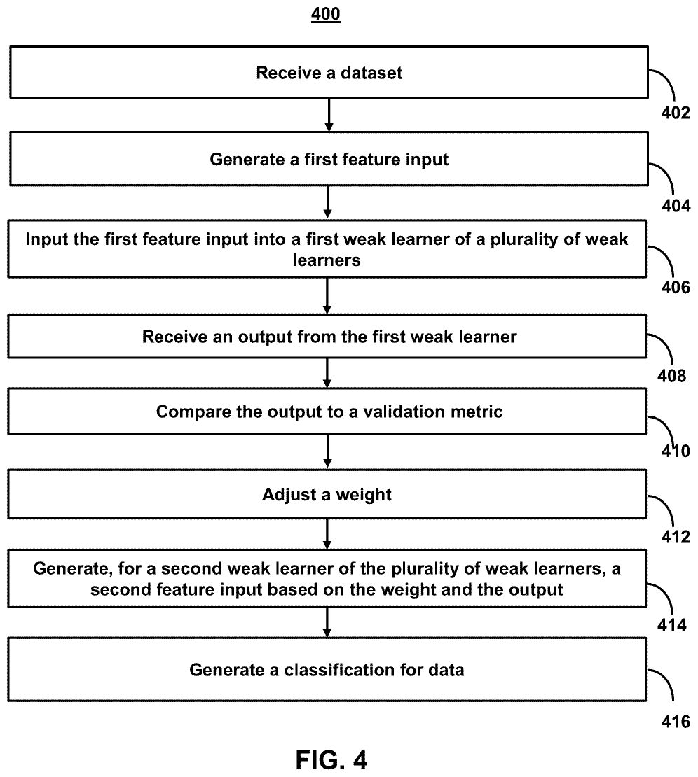

FIG. 4 shows a flowchart of the steps involved in generating flexible ensembles of weak learners using broken series training, in accordance with one or more embodiments. For example, the system may use process 400 (e.g., as implemented on one or more system components described above) in order to generate artificial intelligence models featuring flexible ensembles of weak learners using broken series training. In some embodiments, the system may select the number of rounds (also known as the number of weak learners or base models) in the weak learner ensemble. The optimal number of rounds depends on several factors, including the dataset, the complexity of the problem, and computational resources. For example, the system may specify how many boosting rounds to perform and a validation metric for use internally in the ensemble. Optionally, the system can provide additional weak learning models to be considered at each boosting round in the ensemble, but defaults like decision trees, KNNs, SVMs, logistic regressions, and naïve Bayes models may be provided.

At step 402, process 400 (e.g., using one or more components described above) receives a dataset. For example, the system may receive a first dataset for classification using an artificial intelligence model comprising an ensemble of weak learners. For example, the first dataset may comprise payment card transaction data over a given time period. For example, payment card transaction data refers to the records of financial transactions made using credit cards, debit cards, and/or other electronic payments. These transactions involve the exchange of goods or services in return for payment, and the details of each transaction are recorded by the credit card issuer and the merchant involved. Transaction data is highly valuable for various purposes, including financial analysis, fraud detection, and consumer behavior analysis.

At step 404, process 400 (e.g., using one or more components described above) generates a first feature input. For example, the system may generate a first feature input based on the first dataset. In the context of modeling, a feature input (often simply referred to as a “feature”) is a specific attribute or variable that is used as an input to a model for making predictions or classifications. Features are the measurable characteristics of the data that the machine learning algorithm uses to learn patterns and relationships in the data. In a dataset, each data point (also known as an observation or instance) is described by a set of features. These features represent the input variables that the model uses to make predictions or decisions. The goal of feature engineering is to select and transform relevant features that can help the model capture the underlying patterns in the data and improve its predictive performance.

In some embodiments, the system may separate the first dataset into a training dataset and a validation dataset. The system may determine the first feature input based on the training dataset. The purpose of this separation may be to train the model on one portion of the data and evaluate its performance on another portion to assess how well it generalizes to unseen data. For example, the system may receive an input for classification of a tabular dataset with a validation set already separated out.

At step 406, process 400 (e.g., using one or more components described above) inputs the first feature input into a first weak learner of a plurality of weak learners. For example, the system may input the first feature input into a first weak learner of a plurality of weak learners, wherein the first weak learner corresponds to a first class of a plurality of weak learner classes.

In some embodiments, the system may determine a best-fit criteria for a first round of a weak learner ensemble. The system may then select the first weak learner from the plurality of weak learners based on the first weak learner corresponding to the best-fit criteria. For example, determining the best-fit criteria for a weak learner within an ensemble may depend on the specific classification problem (e.g., whether the model is performing a classification or regression task), data characteristics of the data (e.g., data distribution, the presence of outliers, and the quality of the data), and/or classification goals (e.g., accuracy, precision, etc.). For example, the system may select the best-fit criteria based on a required validation metric (e.g., accuracy, precision, recall, F1-score, AUC-ROC, and AUC-PR. For regression, the system may use metrics like MAE, MSE, RMSE, MAPE, and R-squared) required for subsequent weak learners and the ability of an output of a weak learner to be interpreted. For example, some metrics, like accuracy or MSE, are straightforward to understand, while others, like F1-score, may require more explanation.

At step 408, process 400 (e.g., using one or more components described above) receives an output from the first weak learner. For example, the system may receive a first output from the first weak learner. For example, at each boosting round, the system may fit each one of the possible weak learning models to the residuals from the previous boosting round. The first weak learner may be fit to the original dataset, but every successive learner may be fit to the residuals of the previous one in an effort to correct the errors made. In addition, incorrectly classified observations may have their weight increased as part of the gradient boosting process. When all of the possible base models are fit, the system may evaluate the ensemble model using the validation metric as determined by the system and/or how well it fits to the training set. For example, whichever base model had the best validation score for a given boosting round may be chosen, and the new errors may be propagated with residuals weighted for the next boosting round.

In some embodiments, the system may comprise a weak learner ensemble featuring a gradient boosting model. Gradient Boosting builds a series of decision trees (e.g., weak learners) sequentially. Each tree is trained to correct the errors made by the ensemble of previously trained trees. For example, the system may receive a target value for regression tasks of a weak learner ensemble. As an example, the system may start with an initial prediction, often a constant value such as the mean of the target value for regression tasks or the most common class for classification tasks. This serves as the initial approximation of the target value. The system may then calculate a gradient of a loss function corresponding to the first output. For example, after each tree is built, the system may calculate the gradient (or derivative) of the loss function with respect to the predictions of the current ensemble. The loss function measures the difference between the predicted values and the actual target values. The new decision tree is then fitted to predict the negative gradient of the loss function. That is, the system tries to capture the errors or residuals of the current ensemble. The system may determine a difference between a predicted value and the target value.

In some embodiments, the system may comprise a weak learner ensemble featuring a selected learning rate for the weak learner ensemble. The system may also receive a learning rate. The learning rate, a hyperparameter, may control the step size during gradient descent. For example, the learning rate may scale the contribution of each tree (e.g., weak learner) to the ensemble. Smaller learning rates make the process more robust but may require more trees to achieve good performance.

In some embodiments, the system may reformat outputs of data between weak learner rounds. For example, reformatting data outputs between weak learner rounds in an ensemble learning framework is often necessary to ensure that the outputs from one round of weak learners are suitable as inputs for the next round. To do so, the system may ensure that the outputs of each weak learner are in a consistent and standardized format. This consistency makes it easier to process and combine the outputs. For example, the system may ensure that data types are consistent. If one round outputs numerical values and another outputs categorical values, the system may need to perform additional encoding or transformation for consistency. If the outputs have different scales or ranges, the system may normalize or scale them to ensure consistency. In some embodiments, the system may need to reshape outputs. For example, the system may need to stack or concatenate the outputs of different weak learners horizontally to create a single input matrix for the next round.

In some embodiments, the system may determine a first mapping for the first output based on the first class and determine a second mapping for the first output based on the second class. For example, in AdaBoost, weak learners are often decision stumps that perform binary classification. To convert these binary predictions into real-valued scores, the system may use the following mapping: predicted class “1” is mapped to a positive real number (e.g., +1 or +0.5), and predicted class “−1” is mapped to a negative real number (e.g., −1 or −0.5). The magnitude of the real number represents the confidence or weight assigned to the prediction.

In some embodiments, the system may determine a first probability for the first output based on the first class and determine a second probability for the first output based on the second class. For example, if the system uses weak learners that output class probabilities (e.g., probability of class 0 and class 1), these probabilities can be used directly as inputs for the next round or can be further transformed (e.g., into non-binary outputs) based on the requirements of a weak learner for the next round's weak learner.

In some embodiments, the system may determine a first extraction requirement for the first output based on the first class and apply the first extraction requirement to the first output. For example, the system may perform feature selection or extraction on the combined outputs before feeding them into the next round.

At step 410, process 400 (e.g., using one or more components described above) compares the output to a validation metric. For example, the system may compare the first output to a first validation metric, wherein the first validation metric is based on the first class.

In some embodiments, the system may select a validation metric based on characteristics of the dataset, outputs, and/or classes of weak learners. For example, the system may select an appropriate validation metric for a weak learner by considering the specific task (e.g., classification or regression), the characteristics of the data, and the goals of the weak learner round and/or ensemble prediction.

For example, data in a dataset may have characteristics such as excess noise, imbalance, outliers, etc. The system may select a validation metric based on these data characteristics. For example, for imbalanced data, where one class significantly outnumbers the others, the system may use metrics like F1-score, AUC-ROC, or AUC-PR that are more robust to imbalanced classes. Additionally or alternatively, the system may determine a particular validation metric based on a class of weak learner. For example, some metrics may provide a more intuitive understanding of model performance than others.

At step 412, process 400 (e.g., using one or more components described above) adjusts a weight. For example, the system may adjust a first weight based on comparing the first output to the first validation metric. For example, once all boosting rounds have been completed, the ensemble may contain a series of many diverse weak learners that have all been selected specifically for their performance in reducing misclassifications at each boosting round. When predicting, predictions are run through all the weak learners in series to generate one prediction. After training is complete, the user is returned the completed ensemble model that has been fit for the specified number of boosting rounds to be saved and used for future predictions in production.

At step 414, process 400 (e.g., using one or more components described above) generates, for a second weak learner of the plurality of weak learners, a second feature input based on the weight and the output. For example, the system may generate, for a second weak learner of the plurality of weak learners, a second feature input based on the first weight and the first output.

At step 416, process 400 (e.g., using one or more components described above) generates a classification for data. For example, the system may generate a classification for data in the first dataset based on the second feature input. In some embodiments, generating the classification for data in the first dataset based on the second feature input may comprise the system inputting data into additional rounds and/or weak learners. For example, the system may input the second feature input into the second weak learner of the plurality of weak learners, wherein the second weak learner corresponds to a second class of a plurality of weak learner classes. The system may receive a second output from the second weak learner. The system may compare the second output to a second validation metric, wherein the second validation metric is based on the second class. The system may adjust a second weight based on comparing the second output to the second validation metric. The system may then generate the classification for data in the first dataset based on the second weight and the second output.

In some embodiments, the system may generate the classification based on an ensemble prediction. For example, the system may generate an ensemble prediction based on combining the first output and the second output, wherein the classification is based on the ensemble prediction. For example, the predictions of each decision tree are combined to update the ensemble's prediction. The system may perform this update iteratively, with each new tree (e.g., new weak learner) focusing on reducing the errors made by the previous tree (e.g., weak learner).

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method of generating flexible ensembles of weak learners using broken series training.
2. The method of the preceding embodiment, the method comprising: receiving a first dataset; generating a first feature input based on the first dataset; inputting the first feature input into a first weak learner of a plurality of weak learners, wherein the first weak learner corresponds to a first class of a plurality of weak learner classes; receiving a first output from the first weak learner; comparing the first output to a first validation metric, wherein the first validation metric is based on the first class; adjusting a first weight based on comparing the first output to the first validation metric; generating, for a second weak learner of the plurality of weak learners, a second feature input based on the first weight and the first output; and generating a classification for data in the first dataset based on the second feature input.
3. The method of any one of the preceding embodiments, wherein generating the classification for data in the first dataset based on the second feature input further comprises: inputting the second feature input into the second weak learner of the plurality of weak learners, wherein the second weak learner corresponds to a second class of a plurality of weak learner classes; receiving a second output from the second weak learner; comparing the second output to a second validation metric, wherein the second validation metric is based on the second class; adjusting a second weight based on comparing the second output to the second validation metric; and generating a classification for data in the first dataset based on the second weight and the second output.
4. The method of any one of the preceding embodiments, wherein generating the classification for the data in the first dataset based on the second weight and the second output further comprises: combining the first output and the second output; and generating an ensemble prediction based on combining the first output and the second output, wherein the classification is based on the ensemble prediction.
5. The method of any one of the preceding embodiments, wherein comparing the first output to the first validation metric further comprises: determining that the first weak learner has the first class of the plurality of weak learner classes; and selecting the first validation metric from a plurality of validation metrics based on the first validation metric corresponding to the first class.
6. The method of any one of the preceding embodiments, wherein selecting the first validation metric from the plurality of validation metrics based on the first validation metric corresponding to the first class further comprises: determine a data characteristic of the first dataset; and filtering the plurality of validation metrics based on the data characteristic.
7. The method of any one of the preceding embodiments, wherein inputting the first feature input into the first weak learner of the plurality of weak learners further comprises: determining a best-fit criteria for a first round of a weak learner ensemble; and selecting the first weak learner from the plurality of weak learners based on the first weak learner corresponding to the best-fit criteria.
8. The method of any one of the preceding embodiments, wherein determining the best-fit criteria for the first round of the weak learner ensemble further comprises: determining a data characteristic of the first dataset; and filtering available criteria for the first round of the weak learner ensemble based on the data characteristic.
9. The method of any one of the preceding embodiments, wherein receiving the first output from the first weak learner further comprises: receiving a target value for regression tasks of a weak learner ensemble; calculating a gradient of a loss function corresponding to the first output; and determining a difference between a predicted value and the target value.
10. The method of any one of the preceding embodiments, wherein receiving the first output from the first weak learner further comprises: receiving a learning rate for a weak learner ensemble; and calculating a step size for the weak learner ensemble based on the learning rate.
11. The method of any one of the preceding embodiments, wherein generating the first feature input based on the first dataset further comprises: separating the first dataset into a training dataset and a validation dataset; and determining the first feature input based on the training dataset.
12. The method of any one of the preceding embodiments, further comprising: determining a number of rounds in a weak learner ensemble; and generating the weak learner ensemble with the number of rounds.
13. The method of any one of the preceding embodiments, wherein receiving the first output from the first weak learner further comprises: determining a first format of the first output; and converting the first format to a second format, wherein the second format corresponds to a second class of a plurality of weak learner classes.
14. The method of any one of the preceding embodiments, wherein converting the first format to the second format further comprises: determining a first mapping for the first output based on the first class; and determining a second mapping for the first output based on the second class.
15. The method of any one of the preceding embodiments, wherein converting the first format to the second format further comprises: determining a first probability for the first output based on the first class; and determining a second probability for the first output based on the second class.
16. The method of any one of the preceding embodiments, wherein converting the first format to the second format further comprises: determining a first extraction requirement for the first output based on the first class; and applying the first extraction requirement to the first output.
17. One or more non-transitory, computer readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system of generating artificial intelligence models featuring flexible ensembles of weak learners using broken series training, the system comprising:
one or more processors; and
one or more non-transitory, computer readable mediums comprising instructions recorded thereon that, when executed by the one or more processors, cause operations comprising:
receiving a first dataset for classification using an artificial intelligence model comprising an ensemble of weak learners;
generating a first feature input based on the first dataset;
inputting the first feature input into a first weak learner of a plurality of weak learners in the artificial intelligence model, wherein the first weak learner corresponds to a first class of a plurality of weak learner classes;
receiving a first output from the first weak learner;
comparing the first output to a first validation metric, wherein the first validation metric is based on the first class;
adjusting a first weight based on comparing the first output to the first validation metric;
generating a second feature input based on the first weight and the first output;
inputting the second feature input into a second weak learner of the plurality of weak learners, wherein the second weak learner corresponds to a second class of a plurality of weak learner classes;
receiving a second output from the second weak learner;
comparing the second output to a second validation metric, wherein the second validation metric is based on the second class;
adjusting a second weight based on comparing the second output to a second validation metric; and
generating, from the artificial intelligence model, a classification for data in the first dataset based on the second weight and the second output.

2. A method of generating flexible ensembles of weak learners using broken series training, the method comprising:
receiving a first dataset;
generating a first feature input based on the first dataset;
inputting the first feature input into a first weak learner of a plurality of weak learners, wherein the first weak learner corresponds to a first class of a plurality of weak learner classes;
receiving a first output from the first weak learner;
comparing the first output to a first validation metric, wherein the first validation metric is based on the first class;
adjusting a first weight based on comparing the first output to the first validation metric;
generating, for a second weak learner of the plurality of weak learners, a second feature input based on the first weight and the first output; and
generating a classification for data in the first dataset based on the second feature input.

3. The method of claim 2, wherein generating the classification for data in the first dataset based on the second feature input further comprises:
inputting the second feature input into the second weak learner of the plurality of weak learners, wherein the second weak learner corresponds to a second class of a plurality of weak learner classes;
receiving a second output from the second weak learner;
comparing the second output to a second validation metric, wherein the second validation metric is based on the second class;
adjusting a second weight based on comparing the second output to the second validation metric; and
generating a classification for data in the first dataset based on the second weight and the second output.

4. The method of claim 3, wherein generating the classification for the data in the first dataset based on the second weight and the second output further comprises:
combining the first output and the second output; and
generating an ensemble prediction based on combining the first output and the second output, wherein the classification is based on the ensemble prediction.

5. The method of claim 2, wherein comparing the first output to the first validation metric further comprises:
determining that the first weak learner has the first class of the plurality of weak learner classes; and
selecting the first validation metric from a plurality of validation metrics based on the first validation metric corresponding to the first class.

6. The method of claim 5, wherein selecting the first validation metric from the plurality of validation metrics based on the first validation metric corresponding to the first class further comprises:
determining a data characteristic of the first dataset; and
filtering the plurality of validation metrics based on the data characteristic.

7. The method of claim 2, wherein inputting the first feature input into the first weak learner of the plurality of weak learners further comprises:
determining a best-fit criteria for a first round of a weak learner ensemble; and
selecting the first weak learner from the plurality of weak learners based on the first weak learner corresponding to the best-fit criteria.

8. The method of claim 7, wherein determining the best-fit criteria for the first round of the weak learner ensemble further comprises:
determining a data characteristic of the first dataset; and
filtering available criteria for the first round of the weak learner ensemble based on the data characteristic.

9. The method of claim 2, wherein receiving the first output from the first weak learner further comprises:
receiving a target value for regression tasks of a weak learner ensemble;
calculating a gradient of a loss function corresponding to the first output; and
determining a difference between a predicted value and the target value.

10. The method of claim 2, wherein receiving the first output from the first weak learner further comprises:
receiving a learning rate for a weak learner ensemble; and
calculating a step size for the weak learner ensemble based on the learning rate.

11. The method of claim 2, wherein generating the first feature input based on the first dataset further comprises:
separating the first dataset into a training dataset and a validation dataset; and
determining the first feature input based on the training dataset.

12. The method of claim 2, further comprising:
determining a number of rounds in a weak learner ensemble; and
generating the weak learner ensemble with the number of rounds.

13. The method of claim 2, wherein receiving the first output from the first weak learner further comprises:
determining a first format of the first output; and
converting the first format to a second format, wherein the second format corresponds to a second class of a plurality of weak learner classes.

14. The method of claim 13, wherein converting the first format to the second format further comprises:
determining a first mapping for the first output based on the first class; and
determining a second mapping for the first output based on the second class.

15. The method of claim 13, wherein converting the first format to the second format further comprises:
determining a first probability for the first output based on the first class; and
determining a second probability for the first output based on the second class.

16. The method of claim 13, wherein converting the first format to the second format further comprises:
determining a first extraction requirement for the first output based on the first class; and
applying the first extraction requirement to the first output.

17. One or more non-transitory, computer readable mediums comprising instructions recorded thereon that, when executed by one or more processors, cause operations comprising:
generating a first feature input based on a first dataset;
inputting the first feature input into a first weak learner of a plurality of weak learners, wherein the first weak learner corresponds to a first class of a plurality of weak learner classes;
receiving a first output from the first weak learner;
comparing the first output to a first validation metric, wherein the first validation metric is based on the first class;
adjusting a first weight based on comparing the first output to the first validation metric; and
generating, for a second weak learner of the plurality of weak learners, a second feature input based on the first weight and the first output.

18. The one or more non-transitory, computer readable mediums of claim 17, wherein the instructions further cause operations comprising generating a classification for data in the first dataset based on the second feature input by:
inputting the second feature input into the second weak learner of the plurality of weak learners, wherein the second weak learner corresponds to a second class of a plurality of weak learner classes;
receiving a second output from the second weak learner;
comparing the second output to a second validation metric, wherein the second validation metric is based on the second class;
adjusting a second weight based on comparing the second output to the second validation metric; and
generating a classification for data in the first dataset based on the second weight and the second output.

19. The one or more non-transitory, computer readable mediums of claim 18, wherein generating the classification for the data in the first dataset based on the second weight and the second output further comprises:
combining the first output and the second output; and
generating an ensemble prediction based on combining the first output and the second output, wherein the classification is based on the ensemble prediction.

20. The one or more non-transitory, computer readable mediums of claim 17, wherein comparing the first output to the first validation metric further comprises:
determining that the first weak learner has the first class of the plurality of weak learner classes; and
selecting the first validation metric from a plurality of validation metrics based on the first validation metric corresponding to the first class.
